(19) United States
(12) Patent Application Publication
(10) Pub. No.: US 2018/0100561 A1
(43) Pub. Date: Apr. 12, 2018

(54) SILENT CHAIN

(71) Applicant: TSUBAKIMOTO CHAIN CO., Osaka (JP)

(72) Inventors: Kousuke Fujishima, Osaka-shi (JP); Takeo Sasaki, Osaka-shi (JP); Toshifumi Sato, Osaka-shi (JP)

(73) Assignee: TSUBAKIMOTO CHAIN CO., Osaka (JP)

(21) Appl. No.: 15/730,060

(22) Filed: Oct. 11, 2017

(30) Foreign Application Priority Data
Oct. 12, 2016 (JP) 2016-201002

(51) Int. Cl. F16G 13/04

(52) U.S. Cl. CPC F16G 13/04

(57) ABSTRACT

Provided is a silent chain that enables adjustment of the stiffness and balance of stiffness between upper and lower sides of guide plates, and that prevents long pin failure resulting from deflection or torsional deformation while securing a sufficient area and strength for the portion contacting a side face of a sprocket. The guide plate has a lightening hole with an upper end positioned above a pitch line, and a lower end extending out beyond lines that connect intersections between inner side edges of front and rear pin fitting holes and the pitch line, and a midpoint of a lower end edge of the guide plate in a front to back direction. Outermost portions of the lightening hole in a longitudinal direction are formed within a range that does not go beyond a pair of vertical lines vertical to the pitch line passing through the intersections.

### BACKGROUND OF THE INVENTION

### 1. Field of the Invention

The present invention relates to a silent chain in which guide rows of guide plates and middle plates, and non-guide rows of inner plates are alternately connected along a chain longitudinal direction by pairs of rocker pins each formed of a long pin and a short pin. The present invention also relates to guide plates of the silent chain.

### 2. Description of the Related Art

A silent chain 500, in which guide rows 501 of a pair of left and right guide plates 510 and middle plates 520, and non-guide rows 502 of a plurality of inner plates 530 are alternately connected along the chain longitudinal direction by pairs of rocker pins 504 each formed of a long pin 540 and a short pin 550 as shown in FIGS. 3 to 5, has conventionally been known.

The long pins 540 are securely fitted in pin holes 511 of the guide plates 510 and seated in pin holes of the middle plates 520 and do not rotate relative to the pin holes.

The short pins 550 are seated in pin holes 531 of the inner plates 530 and do not rotate relative to the pin holes.

Thus the long pin 540 and short pin 550 rolling in direct contact with each other allow the chain to flex at the joint between the guide row 501 and the non-guide row 502.

When the silent chain 500 is straight, as shown in FIG. 4, the rolling surface of the long pin 540 and the rolling surface of the short pin 550 are in contact with each other on a pitch line, and the pins can roll both upward and downward.

Since the stiffness against tensile load is different between toothed middle plates 520 and toothless guide plates 510, when such a silent chain 500 is subjected to tension in the chain pitch direction, the less stiff middle plates 520 elongate more in the chain pitch direction than the more stiff guide plates 510, which causes the long pin 540 to warp and sometimes to break.

In order to make the elongation in the guide plates 510 and middle plates 520 equal, for example, the guide plates 510 are provided with lightening holes 512 as shown in FIGS. 3 and 5 so as to reduce the stiffness against tensile load (tensile stiffness) of the guide plates 510 to be equal to the tensile stiffness of the middle plates 520.

Guide plates shown in FIGS. 7 and 8 of Japanese Patent Application Laid-open No. H11-236950 are also known as another design for conventional silent chains that use long pins and short pins.

### SUMMARY OF THE INVENTION

If the lightening hole is simply enlarged to reduce the stiffness, the guide plate cannot have a sufficient area or strength of a portion that makes contact with a side face of the sprocket. While the stiffness in the chain pitch direction of the known guide plate is made equal to that of the middle plate by limiting the hole to a certain size, a good balance of stiffness in the height direction against tension on the pitch line is not taken into consideration. Thus there was a problem that elongation on the pitch line differed from that of the middle plate.

Since the teeth of the middle plates meshing with the sprocket are not positioned on the pitch line, the middle plates are subjected to a force in a direction in which the front and rear teeth are spread apart, which causes deflection or torsional deformation of the long pins. Such deformation is not taken into consideration for the know guide plate.

In high load power transmission applications, in particular, deflection or torsional deformation of the long pins led to vibration or meandering, if not failure, and such vibration or meandering could not be sufficiently suppressed.

The present invention has been contrived to solve these problems, and the object thereof is to provide a silent chain that has a simple shape, that enables adjustment of the stiffness and balance of stiffness between upper and lower sides of guide plates, and that prevents long pin failure resulting from deflection or torsional deformation and suppresses vibration and meandering while securing a sufficient area and strength for the portion contacting a side face of a sprocket.

The silent chain according to the present invention includes: guide rows of guide plates and middle plates; and non-guide rows of inner plates, the guide rows and non-guide rows being alternately connected along a chain longitudinal direction by pairs of rocker pins each formed of a long pin and a short pin. The above object is achieved by the following features: The guide plates each include a pair of front and rear pin fitting holes in which the long pins are fitted, and a lightening hole formed in a middle portion between the front and rear pin fitting holes. The lightening hole is formed such that an upper end thereof is positioned above a pitch line. The lightening hole is formed such that a lower end thereof extends out beyond lines that connect intersections between inner side edges of the front and rear pin fitting holes and the pitch line, and a midpoint of a lower end edge of the guide plate in a front to back direction. Outermost portions of the lightening hole in a longitudinal direction are formed within a range that does not go beyond a pair of vertical lines vertical to the pitch line passing through the intersections.

With the silent chain according to claim 1 and the guide plate according to claim 4, the upper end of the lightening hole is positioned above the pitch line, and the lower end of the lightening hole extends out beyond lines that connect intersections between inner side edges of the front and rear pin fitting holes and the pitch line, and a midpoint of the lower end edge of the guide plate in a front to back direction. Therefore, the balance of stiffness in the height direction of the guide plate against tension on the pitch line can be made equal to that of middle plates so as to make the elongation on the pitch line equal to that of the middle plates. Also, the stiffness in the same direction as the direction of deformation of middle plates meshing with a sprocket can be reduced, so as to prevent failure resulting from deflection or torsional deformation of the long pins and to sufficiently suppress vibration and meandering.

Since the outermost portions of the lightening hole in a longitudinal direction are formed within a range that does not go beyond a pair of vertical lines vertical to the pitch line passing through the intersections, the guide plate can have a sufficient area and strength in the portion contacting a side face of the sprocket.

According to the configuration set forth in claim 2, the upper end of the lightening hole is formed within a range that does not go beyond lines that connect the intersections between the inner side edges of the front and rear pin fitting holes and the pitch line, and a midpoint of an upper end edge of the guide plate in a front to back direction. Thus bending stiffness above the pitch line can be increased and deformation can be made equal to that of the middle plate meshing with the sprocket.

According to the configuration set forth in claim 3, the lightening hole is formed in a rectangular shape, an upper side and a lower side of the lightening hole are parallel to an upper end edge and the lower end edge of the guide plate, respectively, and corners of the lightening hole are rounded. With the lightening hole having such a simple shape, production is made easy.

### BRIEF DESCRIPTION OF THE DRAWINGS

FIG. 1 is an illustrative diagram of a silent chain according to one embodiment of the present invention:

FIG. 2 is a side view of a guide plate of the silent chain according to one embodiment of the present invention;

FIG. 3 is an illustrative diagram of a conventional silent chain;

FIG. 4 is a partial cross-sectional view of the conventional silent chain; and

FIG. 5 is a side view of a guide plate of the conventional silent chain.

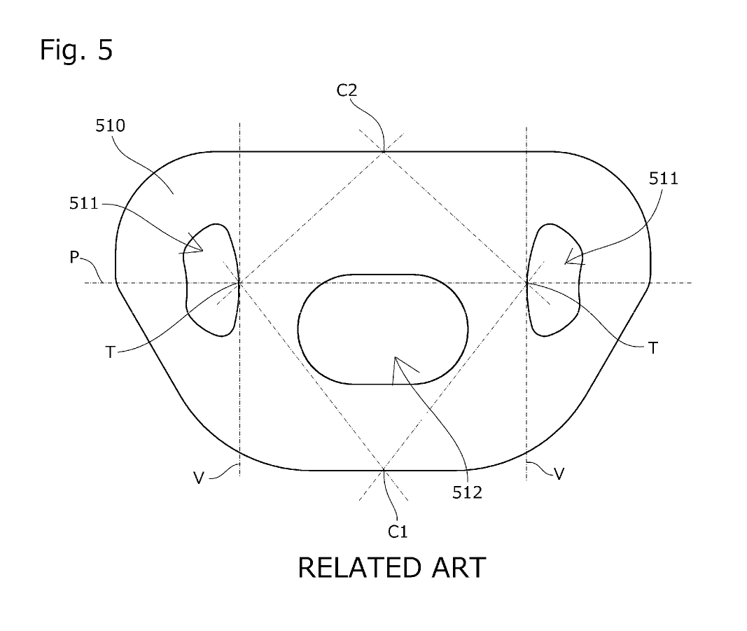

### DESCRIPTION OF THE PREFERRED EMBODIMENT

The present invention is a silent chain in which guide rows of guide plates and middle plates, and non-guide rows of inner plates are alternately connected along a chain longitudinal direction by pairs of rocker pins each formed of a long pin and a short pin. The guide plates each include a pair of front and rear pin fitting holes in which the long pins are fitted, and a lightening hole formed in a middle portion between the front and rear pin fitting holes. The lightening hole is formed such that an upper end thereof is positioned above a pitch line. The lightening hole is formed such that a lower end thereof extends out beyond lines that connect intersections between inner side edges of the front and rear pin fitting holes and the pitch line, and a midpoint of a lower end edge of the guide plate in a front to back direction. Outermost portions of the lightening hole in a longitudinal direction are formed within a range that does not go beyond a pair of vertical lines vertical to the pitch line passing through the intersections. In specific embodiments, the invention may be carried out in any form.

Various constituent elements of the silent chain of the present invention can be made of any materials as long as they have strength for maintaining appropriate tension of the chain. From the viewpoints of strength, machinability, and economy, iron-based materials such as steel, cast iron and the like are preferable. Guide plates, middle plates, and inner plates, in particular, should preferably be formed by punching from a steel sheet.

A silent chain that is one embodiment of the present invention will be hereinafter described with reference to the drawings.

### Embodiment 1

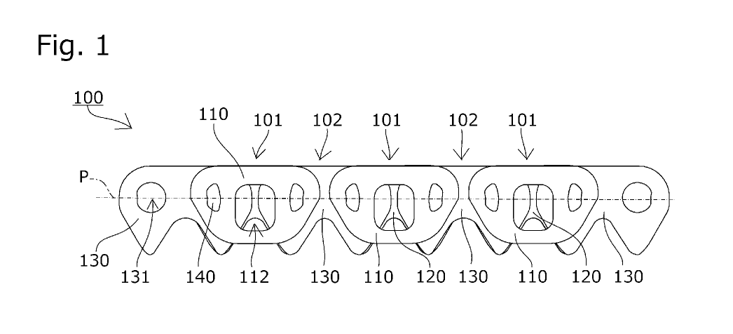

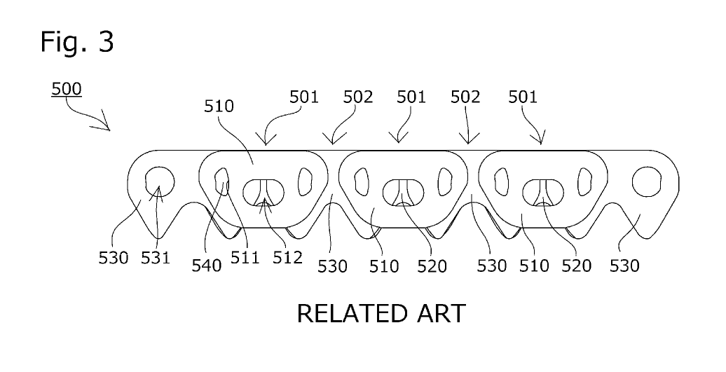

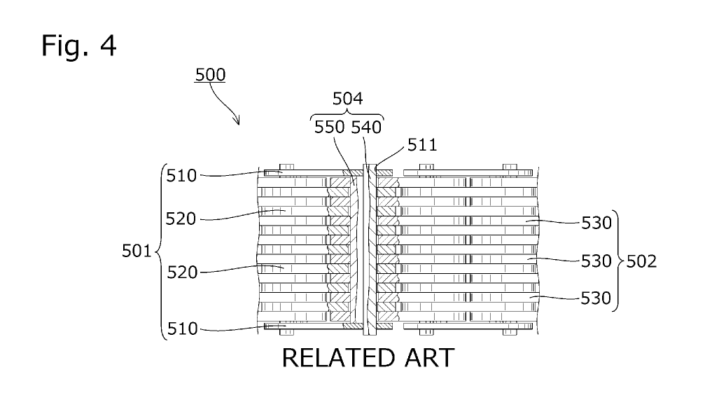

The silent chain 100 that is one embodiment of the present invention is similar to the conventional silent chain 500 shown in FIGS. 3 and 4 except for lightening holes 112 in guide plates 110 as shown in FIG. 1. (Reference numerals given to the elements corresponding to those of FIGS. 3 and 4 begin with 1.)

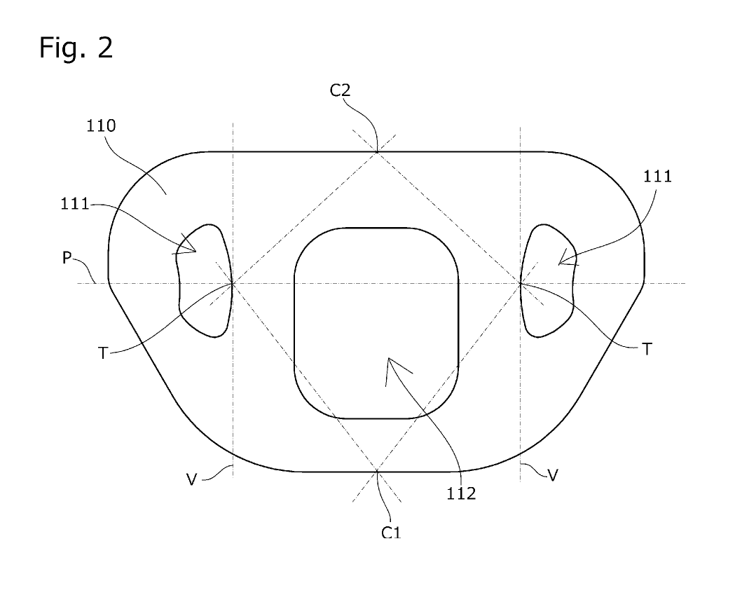

The guide plate 110 includes pin fitting holes 111 in which long pins 140 are securely fitted, and a lightening hole 112 formed in a middle part between the front and rear pin fitting holes 111 as shown in FIG. 2.

In this embodiment, the lightening hole 112 is rectangular. The upper and lower sides of the lightening hole 112 are parallel to the upper end edge and lower end edge of the guide plate 110, respectively. The corners of the lightening hole 112 are rounded.

The lightening hole 112 is formed such that its upper side is located above the pitch line P.

Both ends of the lower side of the lightening hole 112 extend as far as to the outside of lines that connect intersections T between inner side edges of the front and rear pin fitting holes 111 and the pitch line P, and a midpoint C1 in the front to back direction of the lower end edge of the guide plate 110.

Both ends of the lightening hole 112 in the longitudinal direction are formed within a range that does not go beyond a pair of vertical lines V vertical to the pitch line passing through the intersections T.

In this embodiment, both ends of the upper side of the lightening hole 212 are formed within a range that does not go beyond the lines that connect intersections T between inner side edges of the front and rear pin fitting holes 111 and the pitch line P, and a midpoint C2 in the front to back direction of the upper end edge of the guide plate 110.

In the guide plate 110 thus formed, connected portions above and below the lightening hole 112 are present on upper and lower sides of the pitch line P. Therefore, when reducing the stiffness against tension on the pitch line P, the balance of stiffness in the height direction of the guide plate 110 can be readily made equal to that of the middle plate 120 only by adjusting the heights of the upper and lower connected portions, so that elongation on the pitch line P can be made equal to that of the middle plate 120.

Since both ends of the lower side of the lightening hole 112 extend as far as to the outside of lines that connect intersections T between inner side edges of the front and rear pin fitting holes 111 and the pitch line P, and a midpoint C1 in the front to back direction of the lower end edge of the guide plate 110, the bending stiffness of the connected portion below the lightening hole 112 against a force that acts in a twisting direction of the long pin 140 can be reduced. Thus twisting deformation of the long pin 140 caused by a force in a direction in which the teeth of the middle plate 120 are spread apart in the front to back direction as the plate meshes with the sprocket can be mitigated.

Since both ends of the lower side of the lightening hole 112 extend as far as to the outside of lines that connect intersections T between inner side edges of the front and rear pin fitting holes 111 and the pitch line P, and a midpoint C1 in the front to back direction of the lower end edge of the guide plate 110, the bending stiffness of the lower connected portion can be reduced. This enables the guide plate 110 to have a sufficient area and strength in a portion that makes contact with a side face of the sprocket, since there is no need to make thinner the lower connected portion to reduce the stiffness against tension on the pitch line P.

While the lightening hole 112 is rectangular in which corners are rounded in this embodiment, the hole may be trapezoidal, triangular, or polygonal, and each or all of the sides may be formed as curved lines.

What is claimed is:

1. A silent chain comprising: guide rows of guide plates and middle plates; and non-guide rows of inner plates, the guide rows and non-guide rows being alternately connected along a chain longitudinal direction by pairs of rocker pins each formed of a long pin and a short pin,
the guide plates each including a pair of front and rear pin fitting holes in which the long pins are fitted, and a lightening hole formed in a middle portion between the front and rear pin fitting holes,
the lightening hole being formed such that an upper end thereof is positioned above a pitch line,
the lightening hole being formed such that a lower end thereof extends out beyond lines that connect intersections between inner side edges of the front and rear pin fitting holes and the pitch line, and a midpoint of a lower end edge of the guide plate in a front to back direction,
outermost portions of the lightening hole in a longitudinal direction being formed within a range that does not go beyond a pair of vertical lines vertical to the pitch line passing through the intersections.

2. The silent chain according to claim 1, wherein the upper end of the lightening hole is formed within a range that does not go beyond lines that connect the intersections between the inner side edges of the front and rear pin fitting holes and the pitch line, and a midpoint of an upper end edge of the guide plate in a front to back direction.

3. The silent chain according to claim 1, wherein the lightening hole is formed in a rectangular shape,
an upper side and a lower side of the lightening hole are parallel to an upper end edge and the lower end edge of the guide plate, respectively, and
corners of the lightening hole are rounded.

4. A guide plate used in a silent chain including guide rows and non-guide rows alternately connected along a chain longitudinal direction by pairs of rocker pins each formed of a long pin and a short pin, the guide plate comprising:
a pair of front and rear pin fitting holes in which the long pins are fitted; and a lightening hole open in a middle portion between the front and rear pin fitting holes,
the lightening hole being formed such that an upper end thereof is positioned above a pitch line,
the lightening hole being formed such that a lower end thereof extends out beyond lines that connect intersections between inner side edges of the front and rear pin fitting holes and the pitch line, and a midpoint of a lower end edge of the guide plate in a front to back direction,
outermost portions of the lightening hole in a longitudinal direction being formed within a range that does not go beyond a pair of vertical lines vertical to the pitch line passing through the intersections.
